(19) United States
(12) Patent Application Publication
(10) Pub. No.: US 2007/0088571 A1
(43) Pub. Date: Apr. 19, 2007

(54) System and method for improved care provider management

(75) Inventors: Joseph Benjamin Susai, Lake Barrington, IL (US); Michael Thomas Randazzo, Cary, IL (US); Joseph Chowalloor John, Guruvayoor (IN)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/394,683

(22) Filed: Mar. 31, 2006

Related U.S. Application Data
(60) Provisional application No. 60/726,534, filed on Oct. 14, 2005.
(60) Provisional application No. 60/726,537, filed on Oct. 14, 2005.

(51) Int. Cl. G06Q 10/00

(52) U.S. Cl. 705/2

(57) ABSTRACT

Certain embodiments of the present invention provide a system for managing care provider relationships including a user interface component and a database. The user interface component is capable of specifying an association between a patient and a care provider. The association includes a role for the care provider. The database is capable of storing association data. The association data includes one or more associations between patients and care providers.

### RELATED APPLICATIONS

The present application claims the benefit of U.S. Provisional Application No. 60/726,534, filed on Oct. 14, 2005, entitled “System and Method for Care Providers” and U.S. Provisional Application No. 60/726,537, filed on Oct. 14, 2005, entitled “Configurable System and Method for Order Entry,” which are herein incorporated by reference in their entirety.

### FEDERALLY SPONSORED RESEARCH OR DEVELOPMENT

Not Applicable

### MICROFICHE/COPYRIGHT REFERENCE

Not Applicable

### BACKGROUND OF THE INVENTION

The present invention general relates to care provider management. In particular, the present invention relates to systems and methods for improved care provider management.

A patient in a healthcare environment, such as a hospital or clinical, often have one or more care providers assigned to them. Care providers may include, for example, physicians, nurses, pharmacists, and/or other staff members, for example. Care providers may have various roles. Roles may include, for example, admitting physician, primary care physician, pharmacist, referring physician, and attending nurse. The association between a patient and a care provider associates and/or assigns a patient with a care provider with a specific role for the care provider. For example, a patient may be receiving treatment from a particular physician.

Current systems do not provide effective or efficient mechanisms to associate a patient with a care provider. Current systems also do not provide effective or efficient mechanisms to associate a patient with a care provider in a particular role. Some systems allow some associations to be made. For example, an admitting physician may be indicated when a patient is admitted. However, such systems are inflexible and associations cannot be changed during a patient's visit. Thus, there is a need for an effective and efficient mechanism to associate a patient with a care provider. Further, there is a need for an effective and efficient mechanism to associate a patient with a care provider in a particular role.

Current systems do not provide a mechanism to associate a patient with a team of care providers. A team of care providers may define a group of, for example, a physician, nurse, and pharmacist. Teams allow multiple associations to be specified at a single time, thus greatly improving workflow. Thus, there is a need to associate patients with teams of care providers.

Current systems do not allow custom roles to be defined for care providers. Instead, possibly roles for care providers are fixed and/or hard-coded. Custom roles would allow care providers to be associated with patients in capacities that more accurately reflect situations in a particular healthcare environment. That is, there is a need to allow custom roles to be defined to meet the individual needs of a particular healthcare environment. For example, a hospital may prefer one general set of roles to be used whereas as specialized cancer treatment clinic may desire a different, and perhaps more detailed, set of roles.

Currently, if a system provides any support for specifying an association between a patient and a care provider, this must be done through special-purpose application or, potentially, several special-purpose applications. Current systems do not allow associations to be specified through an order entry system. Thus, a user must switch from an order entry system to a special purpose application to make an association. The user may be, for example, a physician or nurse. This is inefficient and hurts workflow for the user. Therefore, there is a need for the capability to make an association between a patient and a care provider through a flexible system, such as through an order entry system.

A clinical decision support system may process rules to trigger an action to occur when a condition is met. Clinical decision support systems often notify a user when some condition occurs. For example, a physician may be emailed when a patient's lab results are available. Current clinical decision support systems maintain their own information regarding who should be notified for a particular patient. However, such systems may not reflect the current situation and may not properly deliver the notification. For example, if the treating physician changes for some reason (e.g., illness or vacation) and a new physician is temporarily assigned to a patient, a notification from the clinical decision support system may go to the unavailable physician and the new physician may not be notified at all. Thus, there is a need for the capability to enable a decision support system to utilize current associations between patients and care providers.

Thus, there is a need for a system and method for improved care provider management.

### BRIEF SUMMARY OF THE INVENTION

Certain embodiments of the present invention provide a system for managing care provider relationships including a user interface component and a database. The user interface component is capable of specifying an association between a patient and a care provider. The association includes a role for the care provider. The database is capable of storing association data. The association data includes one or more associations between patients and care providers.

In an embodiment, the user interface component is capable of displaying the association data. Certain embodiments include an order entry component. The order entry component is capable of generating an order. The order includes an association between the patient and the care provider. Certain embodiments include a clinical decision support component. The clinical decision support component is capable of generating a notification to a user. The user is determined based at least in part on the association data. In an embodiment, the user interface component is capable of defining a team of care providers. In an embodiment, the user interface component is capable of associating the patient a team of care providers. In an embodiment, the user interface component is capable of defining a custom role for the care provider. In an embodiment, the association between the patient and the care provider is temporary.

Certain embodiments of the present invention provide a method for managing care provider relationships including associating a patient with a care provider and storing the association between the patient and the care provider in a database. The association includes a role for the care provider. The database includes association data. The association data includes one or more associations between patients and care providers.

Certain embodiments include displaying the association data. Certain embodiments include generating an order with an order entry component. The order specifies an association between the patient and the care provider. Certain embodiments include generating a notification to a user with a clinical decision support component. The user is determined based at least in part on the association data. Certain embodiments include defining a team of care providers. In an embodiment, the patient is associated with a team of care providers. Certain embodiments include defining a custom role for the care provider.

Certain embodiments of the present invention provide a computer-readable medium including a set of instructions for execution on a computer, the set of instructions including a user interface route and a storage routine. The user interface routine is configured to allow an association between a patient and a care provider to be specified. The association includes a role for the care provider. The storage routine is configured to store the association in association data. The association data includes one or more associations between patients and care providers.

Certain embodiments include an order entry routine configured to generate an order. The order associates the patient with the care provider. Certain embodiments include a clinical decision support routine configured to generate a notification to a user. The user is determined based at least in part on the association data. In an embodiment, the user interface routine is configured to allow an association between the patient and a team of care providers to be specified. In an embodiment, the user interface routine is configured to allow a custom role to be specified.

### BRIEF DESCRIPTION OF SEVERAL VIEWS OF THE DRAWINGS

FIG. 1 illustrates a system for care provider management used in accordance with an embodiment of the present invention.

FIG. 2 illustrates an interface for care provider management used in accordance with an embodiment of the present invention.

FIG. 3 illustrates a flow chart for a method for care provider management used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

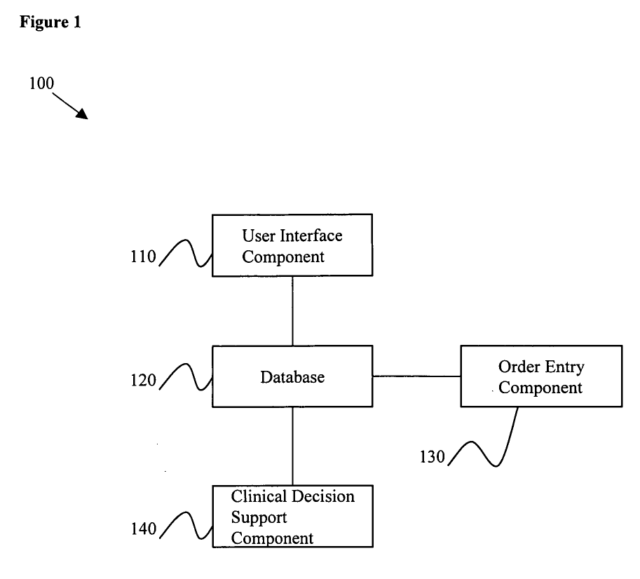

FIG. 1 illustrates a system 100 for care provider management used in accordance with an embodiment of the present invention. The system 100 includes a user interface component 110 and a database 120. In certain embodiments of the present invention, and as illustrated in FIG. 1, the system 100 includes an order entry component 130 and/or a clinical decision support component 140.

The user interface component 110 is in communication with the database 120. The order entry component 130, if present, is in communication with the database 120. The clinical decision support component 140, if present, is in communication with the database 120.

In operation, the user interface component 110 is capable of allowing a user to specify an association between a patient and a care provider. For example, a care provider may be assigned to a patient. As another example, a patient may be assigned to a care provider. Associations between patients and care providers may be deactivated, deleted, and/or changed one or more times.

Care providers may include, for example, physicians, nurses, pharmacists, and/or other staff members, for example. Care providers may have various roles. Roles may include, for example, admitting physician, primary care physician, pharmacist, referring physician, and attending nurse. The association between a patient and a care provider associates and/or assigns a patient with a care provider with a specific role for the care provider. For example, a patient may be receiving treatment from a particular physician. The user interface component 110 may allow the patient to be associated with that physician, with the physician having the role of “treating physician.” As another example, the patient may be assigned to a particular pharmacist after treatment. The user interface component 110 may allow the patient to be associated with that pharmacist with the role of “pharmacist.” In an embodiment, a given care provider may be associated with a patient in one or more roles. Herein, when a patient is associated with a care provider, it is to be understood that the patient is associated with a care provider where the care provider has a specified role.

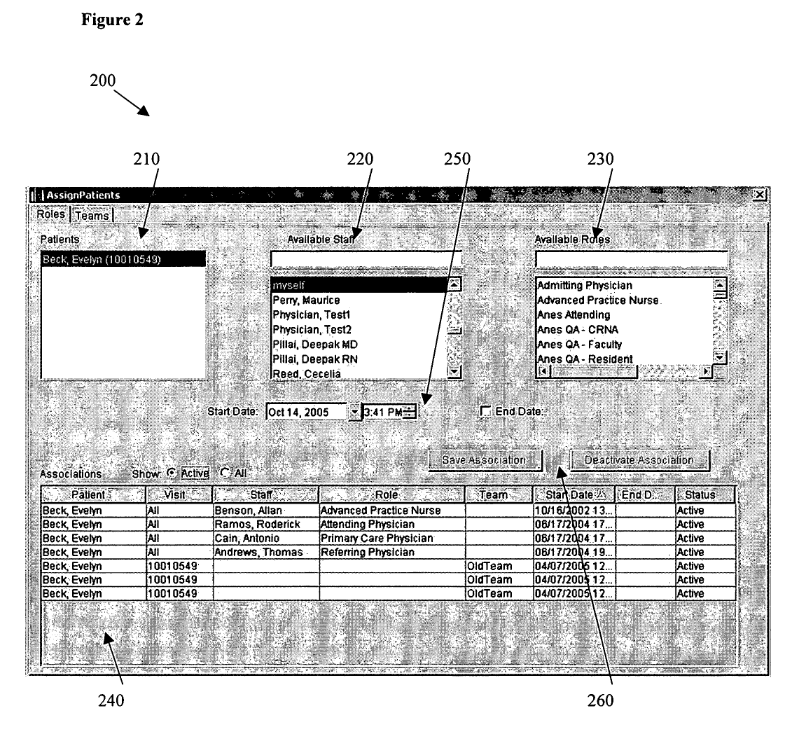

User interface component 110 may include an graphical interface similar to interface 200 discussed below with reference to FIG. 2, for example. As another example, user interface component 110 may include a text and/or command-line based interface.

In an embodiment, the user interface component 110 allows a patient to be associated with a team. A team is a set of associated care providers. Each care provider associated with a team has a specified role. Thus, when a patient is associated with the team, the care providers associated with the team are in turn associated with the patient in their corresponding roles. As an example, a patient may be associated with a “Day Shift” team. At the end of the shift, an order may be entered associating the patient with a “Night Shift” team, thus ensuring that care providers associated with the patient will be available.

A team may be implemented as a special kind of care provider. That is, a single association is made between a patient and the team. For example, a patient may be associated with Team T. Team T may include care providers A and B, with corresponding roles “treating physicians” and “anesthesiologist.” Alternatively, a team may be an abstraction and/or macro. That is, when an association is made between the patient and the team, the user interface component 110 generates a plurality of associations between the patient and the care providers specified to be included in the team. For example, a patient may be associated with Team U. Association with Team U may result in the patient being associated with care provider A in the role of “treating physician” and care provider B in the role of “anesthesiologist.”

Regardless of implementation, discussion of certain embodiments of the present invention will, for the purposes of illustration only, refer to associations between patients and care providers, but it would be understood by one having ordinary skill in the art that those associations may also be between patients and teams.

In an embodiment, the user interface component 110 is capable of allowing a user to define, create, modify, and/or delete a team. For example, the user interface component 110 may include a field to specify a new team name and a list of care providers that may be assigned to the team. As another example, the user interface component 110 may include a list of already created teams and allow a user to modify and/or delete one or more existing teams. In an embodiment, a change to a team is reflected in any associations between patients and that team. In an embodiment, a change to a team is not reflected in any associations between patients and that team.

In an embodiment, the user interface component 110 is capable of allowing a user to define, create, modify, and/or delete custom roles for care providers. That is, the user interface component 110 may include certain hard-coded or pre-defined roles for care providers. In certain embodiments, the user interface component 110 allows a user, such as an administrator, to define custom roles. The custom roles may be specific to the particular healthcare facility and/or patient situation, for example. User interface component 110 may include a field to specify a new role name, for example. User interface component 110 may include fields, controls, and/or options to specify characteristics of the role, for example. For example, a custom role may be limited only to care providers who are physicians.

In an embodiment, the user interface component 110 is capable of displaying one or more prior, current, and/or future associations between patients and care providers. For example, the user interface component 110 may allow a user to see some or all of the care providers currently associated with a particular patient. As another example, the user interface component 110 may allow a user to see all the patients currently associated with a care provider and/or a care provider with a particular role.

In an embodiment, the user interface component 110 allows a care provider to be specified for a single visit. For example, the patient may be associated with Care Provider A as the referring physician for the current visit. In an embodiment, the user interface component 110 allows a care provider to be specified for multiple visits. For example, the patient may be associated with Care Provider B as the primary care physician for the current and future visits. In an embodiment, a patient is associated with care provider for a limited set of visits. For example, the patient may be associated with Care Provider C as the treating physician for all visits. However, the patient may be associated with Care Provider D as the treating physician for the next week because Care Provider D is covering treatments for Care Provider C while Care Provider C is on vacation for the next week.

The association specified by user interface component 110 may be stored in database 120. Database 120 is capable of storing association data. Association data includes one or more associations between patients and care providers. For example, a Patient X may be associated with Care Provider A. In addition, Patient Y may be associated with Care Provider B. Each association may be included in the association data stored in database 120.

Further, a given patient (e.g., Patient X), may have multiple associations in database 120. That is, Patient X may be associated with Care Provider A, as previously discussed. Additionally, association data stored in database 120 may include an association between Patient X and Care Provider C. As another example, association data may include an association between Patient X and Care Provider T, where Care Provider T is a team of care providers.

In certain embodiments, the system 100 includes an order entry component 130. The order entry component 130 may be a flexible system, for example. The order entry component 130 may allow a user to write orders for a patient, for example. For example, a user may specify medications to be administered to the patient with the order entry component 130. As another example, a user may schedule a procedure for a patient using the order entry component 130. As another example, the order entry component 130 may by capable of allowing a user to review, change, and/or cancel existing orders; configure default rules for specifying an order; provide interaction checking for medications ordered; and/or allow a user to define and/or utilize an order set to issue a collection of orders with one command.

In an embodiment, the order entry component 130 is capable of allowing a patient to be associated with a care provider. That is, a user may specify an association between a patient and a care provider with the order entry component 130. A user may thus use the order entry component 130 to associate a patient with a care provider while writing other orders with the order entry component 130, greatly improving workflow without require the user to change applications, screens, tabs, and/or interfaces, for example. The association specified with the order entry component 130 may be stored in the database 120, similar to an association specified with the user interface component 110, described above, for example.

In certain embodiments, the system 100 includes a clinical decision support component 140. The clinical decision support component may be capable of notifying a care provider, for example. The clinical decision support component 140 may process rules. The rules may specify an action, such as altering a care provider, to occur when a condition is met. For example, a rule may specify that a patient's primary care physician should be notified when exam results become available. The clinical decision support component 140 may utilize association data stored in the database 120 to determine the care provider in the designated role for a particular patient, for example.

The components, elements, and/or functionality of system 100 may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device.

FIG. 2 illustrates an interface 200 for care provider management used in accordance with an embodiment of the present invention. The interface 200 may be included in a user interface component, for example. The user interface component may be similar to user interface component 110, described above, for example.

The interface 200 includes a patient list 210, a care provider list 220, a role list 230, an association display 240, a time frame specifier 250, and association controls 260. It should be emphasized that the following discussion of interface 200 is as depicted in FIG. 2, but that other implementations, layouts, and controls are possible and would be known to one having ordinary skill in the art.

In operation, interface 200 allows an association between a patient and a care provider to be specified. For example, a care provider may be assigned to a patient. As another example, a patient may be assigned to a care provider. The association between the patient and the care provider may include a specific role for the care provider, for example.

The patient to be associated may be specified using patient list 210. Patient list 210 may list one or more patients available to be associated. For example, patient list 210 may list every patient in the hospital. As another example, patient list 210 may list patients assigned to the department of the user of interface 200. In an embodiment, patient list 210 may be searched and/or filtered by the user. For example, the user may specify a partial first and/or last name and patient list 210 may list only patients that match that partial first and/or last name.

Care provider list 220 allows the care provider to be associated with the patient to be specified. The patient may be the patient specified using patient list 210, for example. As another example, in a different implementation, the patient may be specified at a prior or subsequent step. Care provider list 220 may list one or more care providers available to be associated. For example, care provider list 220 may list care providers assigned to the department of the user of interface 200. As another example, care provider list 220 may include all care providers of a specific type (e.g., nurse or physician) or all care providers scheduled to work on a given day. In an embodiment, care provider list 220 may be searched and/or filtered by the user. For example, the user may specify a partial first and/or last name and care provider list 220 may list only care providers that match that partial first and/or last name. In an embodiment, care provider list 220 includes a special entry that designates the user as the care provider to be associated with the patient. For example, care provider list 220 may include an entry in the list of available care providers named “myself” which, if selected, associates the patient with the user.

The association between the patient and the care provider may include a specified role for the care provider. The role for the care provider for the association may be specified with role list 230, for example. As another example, in a different implementation, the role of the care provider may be fixed and/or pre-assigned based at least in part on the nature of the care provider (e.g., a care provider who is a pharmacist may always be assigned the pharmacist role). Role list 230 may list one or more roles available to be associated. For example, role list 230 may list available roles to be assigned with respect to the patient. That is, role list 230 may not include roles which have already been associated with respect to a given patient. As another example, role list 230 may list available roles to be assigned with respect to the care provider. That is, role list 230 may not include roles to which a care provider cannot be assigned. For example, a nurse cannot be associated in the “treating physician” role. In an embodiment, role list 230 may be searched and/or filtered by the user. For example, the user may specify a partial role name and role list 230 may list only roles that match that partial role name.

The interface 200 may be capable of displaying association data. Association data may be displayed by association display 240, for example. Association display 240 may display information including patient, care provider, role, team, time frame, and/or associated visit, for example. Association display 240 may be capable of displaying one or more prior, current, and/or future associations between patients and care providers, for example. For example, association display 240 may allow a user to see some or all of the care providers currently associated with a particular patient. The particular patient may be the patient currently specified in the patient list, for example. As another example, association display 240 may allow a user to see all the patients currently associated with a particular care provider and/or a care provider with a particular role. The particular care provider may be the care provider currently specified in care provider list 220, for example. The particular role may be the role currently specified in role list 230, for example.

As discussed above, an association between a patient and a care provider may be for a single visit, multiple visits, or all subsequent visits until later specified, for example. Also, an association between a patient and a care provider may be temporary and/or for a limited set of visits, as discussed above. Time frame specifier 250 allows a care provider to be specified for a single visit, for multiple visits, all subsequent visits. In addition, time frame specifier 250 allows a temporary and/or limited set of visits to be specified for the association.

Once an association has been configured using, for example, patient list 210, care provider list 220, role list 230, and/or time frame specifier 250, the association may be specified to the system and/or saved using association controls 260. The association may be specified to a system similar to system 100, discussed above, for example. The association may be saved and/or stored in a database similar to database 120, discussed above, for example. Association controls 260 may also allow associations to be deactivated and/or removed, for example. An association to be deactivated and/or removed may be specified by selecting the association in association list 240, for example.

In an embodiment, interface 200 allows a patient to be associated with a team. The association between a patient and a team may be similar to the association between a patient and team described above, for example.

In an embodiment, interface 200 is capable of allowing a user to define, create, modify, and/or delete a team. For example, interface 220 may include a field to specify a new team name and a list of care providers that may be assigned to the team. As another example, interface 200 may include a list of already created teams and allow a user to modify and/or delete one or more existing teams.

In an embodiment, interface 200 is capable of allowing a user to define, create, modify, and/or delete custom roles for care providers. That is, interface 200 may include certain hard-coded or pre-defined roles for care providers. In certain embodiments, interface 200 allows a user, such as an administrator, to define custom roles. The custom roles may be specific to the particular healthcare facility and/or patient situation, for example. Interface 200 may include a field to specify a new role name, for example. Interface 200 may include fields, controls, and/or options to specify characteristics of the role, for example. For example, a custom role may be limited only to care providers who are physicians.

The components, elements, and/or functionality of interface 200 may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device.

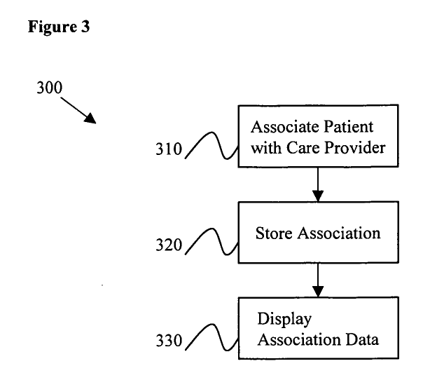

FIG. 3 illustrates a flow chart for a method 300 for care provider management used in accordance with an embodiment of the present invention. The method 300 includes the following steps, which will be described below in more detail. At step 310, a patient is associated with a care provider. At step 320, an association is stored. At step 330, association data is displayed. The method 300 is described with reference to elements of systems described above, but it should be understood that other implementations are possible.

At step 310, a patient is associated with a care provider. A patient may be associated with a care provider with a user interface component or interface, for example. The user interface component may be similar to user interface component 110, described above, for example. The interface may be similar to interface 200, described above, for example. In an embodiment, the association between the patient and the care provider may be specified by an order entry component. The order entry component may be similar to order entry component 130, described above, for example.

The association between the patient and the care provider may be created, defined, and/or specified. For example, a care provider may be assigned to a patient. As another example, a patient may be assigned to a care provider. The association between the patient and the care provider may include a specific role for the care provider, for example. In an embodiment, the patient is associated with a team. The association between a patient and a team may be similar to the association between a patient and team described above, for example.

At step 320, an association is stored. The association may be the association created, defined, and/or specified at step 310, for example. The association may be stored in a database. The database may be similar to database 120, described above, for example. In certain embodiments, the stored association is available to other components. For example, an order entry component and/or a clinical decision support component may utilize the stored association. The order entry component may be similar to order entry component 130, described above, for example. The clinical decision support component may be similar to clinical decision support component 140, described above, for example.

At step 330, association data is displayed. The association data may be stored in a database, for example. The database may be similar to database 120, described above, for example. For example, the association data displayed may be similar to and/or based at least in part on the association data stored in database 120, described above. The association data may be displayed by a user interface component or interface, for example. The user interface component may be similar to user interface component 110, described above, for example. The interface may be similar to interface 200, described above, for example. The association data may be displayed by an association display. The association display may be similar to association display 240, described above, for example. The association data may reflect the association created, defined, and/or specified at step 310, for example. The association data may reflect the association stored at step 320, for example.

One or more of the steps of the method 300 may be implemented alone or in combination in hardware, firmware, and/or as a set of instructions in software, for example. Certain embodiments may be provided as a set of instructions residing on a computer-readable medium, such as a memory or hard disk, for execution on a computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments of the present invention provide an effective and efficient mechanism to associate a patient with a care provider. Further, certain embodiments provide an effective and efficient mechanism to associate a patient with a care provider in a particular role. Certain embodiments allow patients to be associated with teams of care providers. Certain embodiments allow custom roles to be defined. Certain embodiments provide the capability to make an association between a patient and a care provider through an order entry system. Certain embodiments provide the capability to enable a decision support system to utilize current associations between patients and care providers.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for managing care provider relationships, the system including:
a user interface component, wherein the user interface component is capable of specifying an association between a patient and a care provider, wherein the association includes a role for the care provider; and
a database, wherein the database is capable of storing association data, wherein the association data includes one or more associations between patients and care providers.

2. The system of claim 1, wherein the user interface component is capable of displaying the association data.

3. The system of claim 1, further including an order entry component, wherein the order entry component is capable of generating an order, wherein the order includes an association between the patient and the care provider.

4. The system of claim 1, further including a clinical decision support component, wherein the clinical decision support component is capable of generating a notification to a user, wherein the user is determined based at least in part on the association data.

5. The system of claim 1, wherein the user interface component is capable of defining a team of care providers.

6. The system of claim 1, wherein the user interface component is capable of associating the patient a team of care providers.

7. The system of claim 1, wherein the user interface component is capable of defining a custom role for the care provider.

8. The system of claim 1, wherein the association between the patient and the care provider is temporary.

9. A method for managing care provider relationships, the method including:
associating a patient with a care provider, wherein the association includes a role for the care provider; and
storing the association between the patient and the care provider in a database, wherein the database includes association data, wherein the association data includes one or more associations between patients and care providers.

10. The method of claim 9, further including displaying the association data.

11. The method of claim 9, further including generating an order with an order entry component, wherein the order specifies an association between the patient and the care provider.

12. The method of claim 9, further including generating a notification to a user with a clinical decision support component, wherein the user is determined based at least in part on the association data.

13. The method of claim 9, further including defining a team of care providers.

14. The method of claim 9, wherein the patient is associated with a team of care providers.

15. The method of claim 9, further including defining a custom role for the care provider.

16. A computer-readable medium including a set of instructions for execution on a computer, the set of instructions including:
a user interface routine configured to allow an association between a patient and a care provider to be specified, wherein the association includes a role for the care provider; and
a storage routine configured to store the association in association data, wherein the association data includes one or more associations between patients and care providers.

17. The set of instructions of claim 16, further including an order entry routine configured to generate an order, wherein the order associates the patient with the care provider.

18. The set of instructions of claim 16, further including a clinical decision support routine configured to generate a notification to a user, wherein the user is determined based at least in part on the association data.

19. The set of instructions of claim 16, wherein the user interface routine is configured to allow an association between the patient and a team of care providers to be specified.

20. The set of instructions of claim 16, wherein the user interface routine is configured to allow a custom role to be specified.
